(19) United States
(12) Patent Application Publication
(10) Pub. No.: US 2026/0194177 A1
(43) Pub. Date: Jul. 9, 2026

(54) TRIPOD FOR HOLDING A SMARTPHONE

(71) Applicant: Photographic Research Organization, Inc., Fairfield, CT (US)

(72) Inventor: Paul ORZEL, Sagamore Hills, OH (US)

(73) Assignee: Photographic Research Organization, Inc., Fairfield, CT (US)

(21) Appl. No.: 19/128,492

(22) PCT Filed: Nov. 20, 2023
(86) PCT No.: PCT/US2023/080560

§ 371 Date: May 8, 2025

Related U.S. Application Data
(60) Provisional application No. 63/427,528, filed on Nov. 23, 2022.

(51) Int. Cl. F16M 11/04; F16M 11/14; F16M 11/16; F16M 11/32; G03B 17/56; H04M 1/04

(52) U.S. Cl. CPC F16M 11/041; F16M 11/14; F16M 11/16; F16M 11/32; G03B 17/561; H04M 1/04

(57) ABSTRACT

A tripod incorporates a miniature tripod having legs which can be quickly removed from a yoke of the main tripod and can perform multiple functions including a hand-held stabilizer, a tabletop mini tripod, or a 3-point base for a built-in monopod. A tripod as disclosed herein also includes a mounting device in which the top platform is convertible, allowing it to connect with a camera via a quick release system or to hold a smartphone for use as a camera.

### CROSS REFERENCE TO RELATED APPLICATIONS

This is a U.S. national stage of application No. PCT/US2023/080560, filed on Nov. 20, 2023. This application claims priority to U.S. Provisional Application Ser. No. 63/427,528 filed Nov. 23, 2022, incorporated herein by reference.

### BACKGROUND

Tripods are used to improve photography by providing a stable platform for a camera, whether capturing still images or videos. A stable platform that can be used in a variety of ways is especially helpful in locations outside a studio, where equipment may be carried a considerable distance.

Depending on an image capture situation, a photographer may prefer to use a tripod, a tabletop tripod, or a monopod. A typical multipurpose tripod includes folding legs that are extendable between 3 and 8 feet, for example, whereas a tabletop tripod may include shorter legs that may or may not be capable of adjustment. A monopod may be a separate device or may be a single leg removed from a tripod.

A tripod also includes a head with a platform for securing an image capture device. In addition to legs that may be adjusted in a variety of ways, the tripod head may also be adjusted using a ball head and/or other mechanisms for adjusting the tilt and rotation of an image capture device.

The incorporation of cameras in smartphones has led to interest in holding a smart phone on a tripod for the purposes of improving both still photography as well as videography. As used herein, the term “camera” refers to a dedicated device for still image or video capture, which typically includes a threaded port (typically a common ¼″-20 or ⅜″-16 thread) for attachment to the platform of a tripod. The term “smartphone” typically refers to a device where image capture is only one of many functions of the device. A smartphone may encompass a mobile device, a tablet, or any similar device. A smartphone does not typically include a threaded port in its housing.

Increasingly, photographers carry both cameras as well as smartphones having a camera function, and use both for image capture. Photographers may choose to use either device with a tripod. Cameras are secured to a tripod using the threaded port and a threaded post on the tripod. It is also known to mount a quick release (QR) plate using the threaded port on the camera, which is then attached to the tripod using a QR receiver.

Most tripods accomplish the mounting of a smartphone to a tripod using a separate mechanism from that used to attach a camera. An adapter is typically a separate part from the tripod that clamped around the smartphone, and includes the threaded port found on cameras and connects to the tripod similarly.

Some prior art products have the ability to hold a camera or a phone without the need for a separate adapter. This type of convertible top platform connects to a camera using a common ¼″-20 bolt (as opposed to a quick release system). Connecting to a camera using the ¼″-20 bolt takes time. When the tripod is deployed it is a slow process to align the bolt with the female, threaded port in the base of the camera. Once aligned, the parts are connected using a thumb screw. This connection must then be undone each time the camera is removed from the tripod.

Another prior art item uses a quick release QR plate that converts to a phone holder. In this known item, the phone holder is part of the QR plate that may be attached to the threaded port in a camera rather being a separate adaptor that is secured to the tripod head. There is a significant disadvantage because the photographer must take time to unscrew the QR plate from the base of the camera before it can be converted into a phone holder and then attached to the tripod.

Known devices for using one tripod with both cameras and smartphones typically require disconnecting a threaded mount as part of switching the tripod from one to the other. This takes a significant amount of time and may impact a photographer's ability to capture desirable images.

### SUMMARY OF THE INVENTION

In a first aspect, a tripod functions as a main tripod and a miniature (“mini”) tripod, at least one of which having legs which can be quickly removed from a yoke of the main tripod and can perform multiple functions including a hand-held stabilizer, and a 3-point base for a built-in monopod, for example.

In a second aspect, a tripod for holding a smartphone includes a mounting device in which the top platform of the tripod's head is convertible, allowing it to connect with a camera via a quick release system or to hold a smartphone for use as a camera.

In accordance with a disclosed embodiment, a mounting device is described for securing image capture devices, the mounting device being convertible between an open position and a closed position. The mounting device comprised a base having a base bottom surface securable to a tripod head and a base top surface; a platform having a platform top surface forming a quick release (QR) receiver and a platform bottom surface forming a mobile device clamp; a hinge connecting an edge of the platform to an edge of the base; and a retaining clasp for retaining the platform bottom surface against the base top surface in the closed position and releasing the platform from the base in the open position.

In accordance with another disclosed embodiment, A tripod includes a yoke with a central opening; three legs hingeably attached to the yoke around a circumference of the yoke; a tripod head with a first threaded connection mechanism; a mini tripod assembly, having a second threaded connection mechanism compatible with the first threaded connection mechanism of the tripod head; a minibase connected to the second threaded connection mechanism; three minilegs hingeably attached to the minibase; and a release knob in the yoke for releasably retaining the mini tripod assembly in the opening of the yoke.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

In the drawings:

FIG. 1 shows a tripod including a mounting device and an incorporated mini tripod assembly, in embodiments.

FIG. 2 shows a top view of a yoke of the tripod of FIG. 1, in embodiments.

FIG. 3 shows the mini tripod assembly of FIG. 1 in a deployed configuration, in embodiments.

FIG. 4 shows mini tripod assembly 104 during removal from the tripod, in embodiments.

FIG. 5 shows the mini tripod assembly after removal from yoke, in an undeployed configuration, in embodiments.

FIGS. 6A-6D show the mini tripod assembly as a base for a monopod, in embodiments.

FIG. 7A shows the mounting device of FIG. 1 in closed position, in embodiments.

FIG. 7B shows the mounting device of FIG. 1 in an open position, in embodiments.

FIGS. 8A and 8B show top views of the mounting device of FIGS. 7A and 7B, in embodiments.

FIG. 8C shows the mounting device of FIGS. 7A and 7B in a partially open position, in embodiments.

FIGS. 9A-9C show steps of converting the mounting device of FIG. 1 from a camera mode to a smartphone mode, in embodiments.

FIGS. 10A-10B show side and back views of the mounting device of FIG. 1 in use with a smartphone, in embodiments.

FIGS. 11A-11D show the operation of a quick release (QR) system with the mounting device of FIG. 1, in embodiments.

### DETAILED DESCRIPTION OF THE DISCLOSED EMBODIMENTS

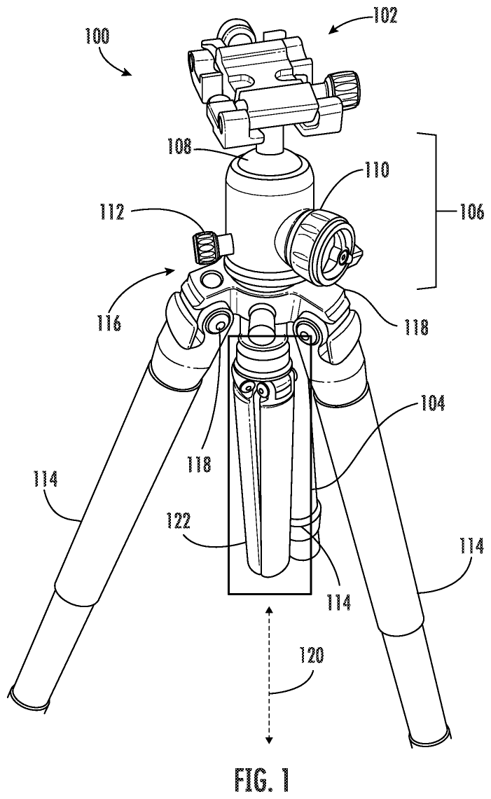

FIG. 1 shows a tripod 100 including a mounting device 102 and a mini tripod assembly 104, in embodiments. Mounting device 102 is part of tripod head 106, which may include ball head 108 and adjustment knobs 110 and 112. These features may be used to position platform 152 in a preferred angle or degree of rotation as would be understood by one of ordinary skill in the art. Although a representative tripod head is shown in the drawings for purposes of illustration, mounting device 102 may be used with tripod heads having configurations and features other than those shown. In addition, other features such as levers and handles (not shown) may be attached to tripod head 106 and/or mounting device 102.

Tripod 100 includes legs 114 which are attached to yoke 116 by a leg hinge 118, which allows legs 114 to pivot towards each other along centerline 120 or away from centerline 120 to provide stability as shown in FIG. 1. Legs 114 may also include nested telescoping sections that allow each leg 114 to be extended, as would be understood by one of ordinary skill in the art.

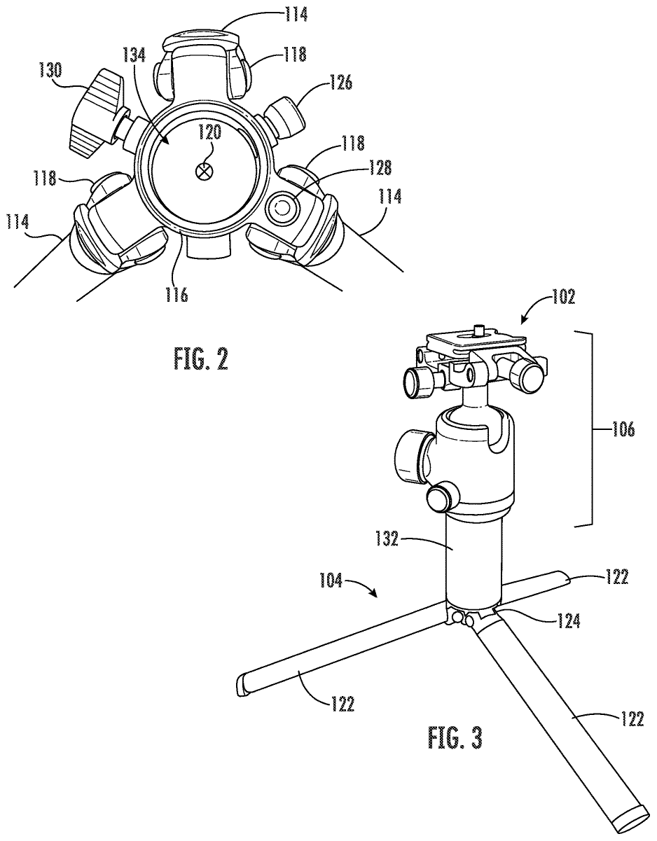

Mini tripod assembly 104 is inserted through yoke 116, shown in more detail in FIG. 2. Mini tripod assembly 104 may be removed from yoke 116 and used separately, with or without either of tripod head 106 and mounting device 102. As shown in FIG. 1, and in more detail in FIGS. 2 and 3, mini tripod assembly 104 is attached to tripod head 106 and inserted through yoke 116, where it may be retained using one or more threaded knobs. Mini tripod assembly 104 includes three minilegs 122 attached to minibase 124. In FIG. 1, minilegs 122 are positioned along centerline 120 in an undeployed configuration. Minilegs 122 extend below yoke 116 to a distance such that they do not interfere with legs 114 when folded in towards centerline 120. In embodiments, mini tripod assembly 104 may be used with tripod heads and platforms having configurations and features other than those shown.

FIG. 2 shows a top view of yoke 116 after mini tripod assembly 104 and tripod head 106 have been removed. Yoke 116 is generally circular around centerline 120 and includes a central opening 134. Release knob 130 is located on a side of yoke 116 and serves as a quick release mechanism so that mini tripod assembly 104 may be quickly deployed from yoke 116. Release knob 130 may be threaded or spring-loaded. In embodiments, retention screw 126 may be threaded into another section of yoke 116 to provide a more secure attachment of mini tripod assembly 104. In embodiments, yoke 116 may also be referred to as a “spider.” Yoke 116 may include other features, such as leveling bulb. Handles (not shown) may also be attached to yoke 116. In embodiments, legs 114 are evenly distributed around a circumference of yoke 116.

FIG. 3 shows mini tripod assembly 104 and tripod head 106 after they have been removed from yoke 116, where minilegs 122 are deployed in a configuration for use on a table top or other surface. In embodiments, minilegs 122 are attached to minibase 124 using hinges that allow minilegs 122 to be securely positioned at a variety of angles relative to minibase 124. This allows mini tripod assembly 104 to be used for sturdy low-angle shots and macro work. In embodiments, minilegs 122 are evenly distributed around a circumference of minibase 124

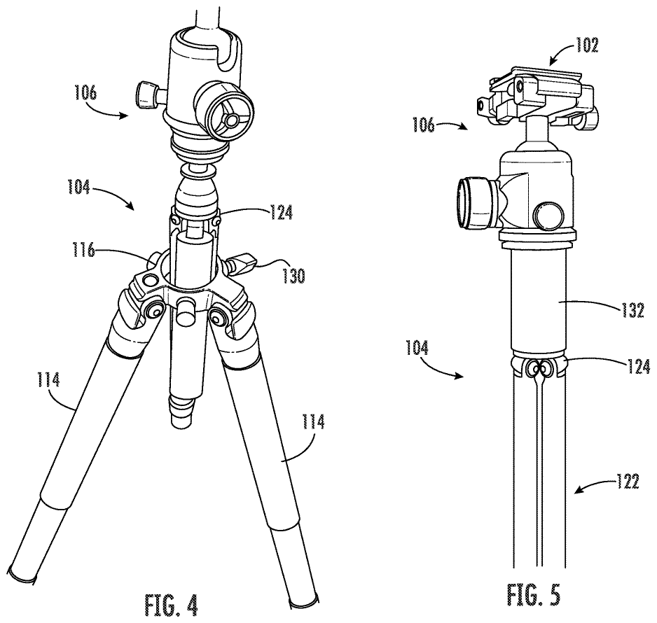

FIG. 4 shows mini tripod assembly 104 and tripod head 106 as they are being removed from yoke 116. After release knob 130 is either twisted or pulled away from yoke 116, tripod head 106 may be lifted away from yoke 116 so that mini tripod assembly 104 passes through the center of yoke 116. In addition to the deployed configuration shown in FIG. 3, mini tripod assembly 104 may also be used where minilegs 122 remain in an undeployed configuration.

FIG. 5 shows the mini tripod assembly 104 after removal from yoke 116 where minilegs 122 are not deployed. In this configuration, mini tripod assembly 104 may be used as a handheld stabilizer for video work, for example. Tube 132 also includes a threaded connection for attachment to tripod head 106 as explained in more detail below. Although a specific attachment mechanism is shown in the drawings, this if for purposes of illustration only and other mechanisms may be used.

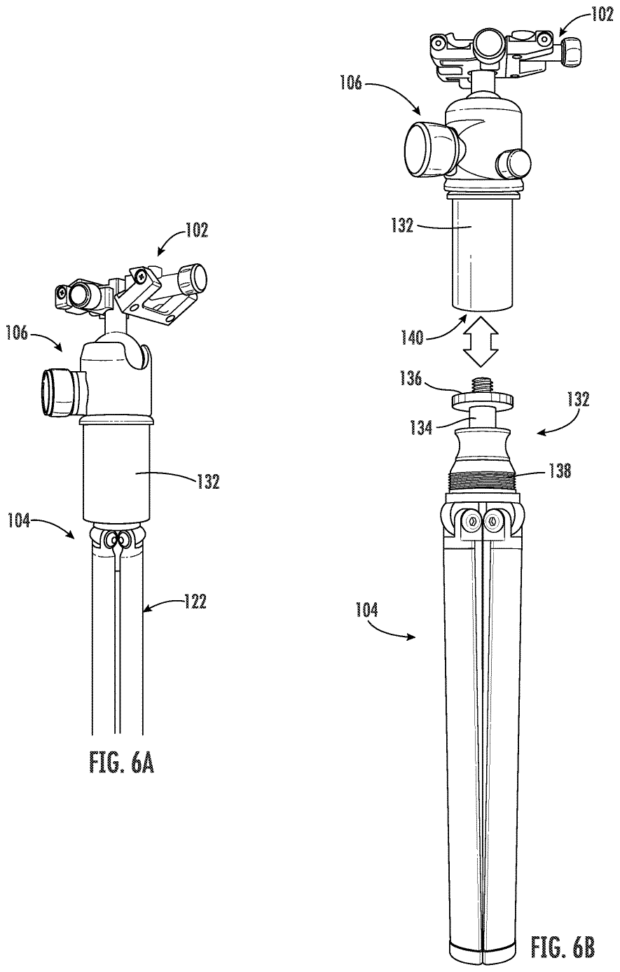

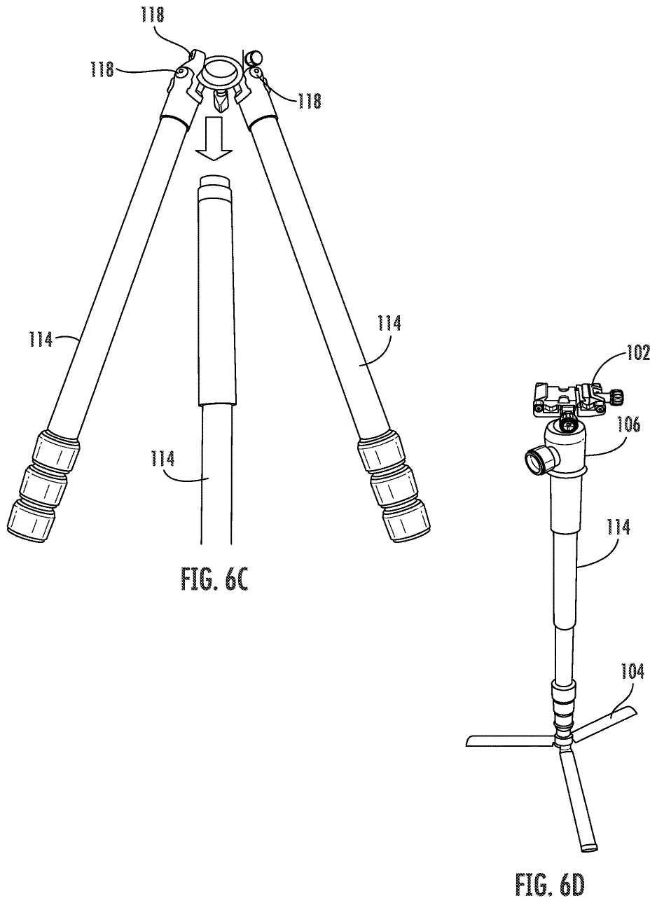

In embodiments, mini tripod assembly 104 may also be used as a base for a monopod, as shown in FIGS. 6A-6D . FIG. 6A shows mounting device 102, tripod head 106 and mini tripod assembly 104 after removal from yoke 116. Minilegs 122 are in an undeployed configuration.

In FIG. 6B, mini tripod assembly 104 has been removed from tripod head 106. Internal threads 140 in the lower end of tube 132 engage from external threads 138 on mini tripod assembly 104. In embodiments, tube 132 covers components such as platform 136 to enable mini tripod assembly 104 to be connected directly to a camera, for example.

FIG. 6C shows tripod 100 of FIG. 1 with one of legs 114 detached from yoke 116 just below hinge 118. In embodiments, leg 114 is attached to yoke 116 using a threaded connection matching the external threads 138 on mini tripod assembly 104 but other connections may be used.

Then, as can be seen in FIG. 6D, mini tripod assembly 104 may be attached to single leg 114 to form a monopod with a 3-point base. Tube 132 of tripod head 106 with mounting device 102 is connected to the top of the single leg 114 to complete the monopod assembly.

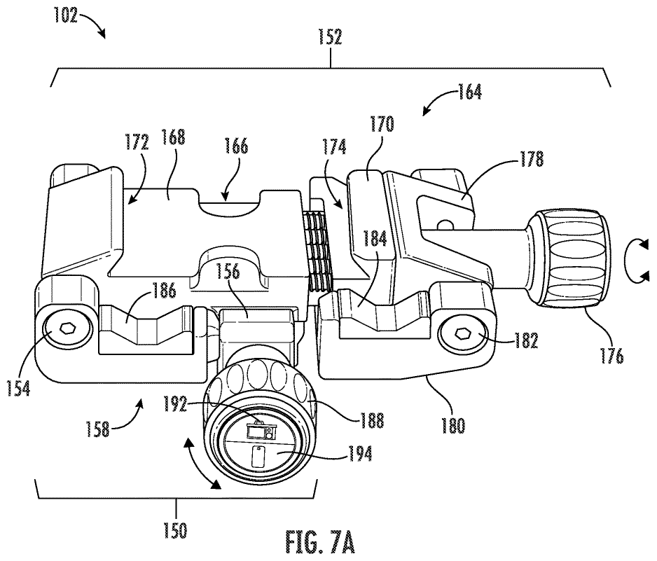

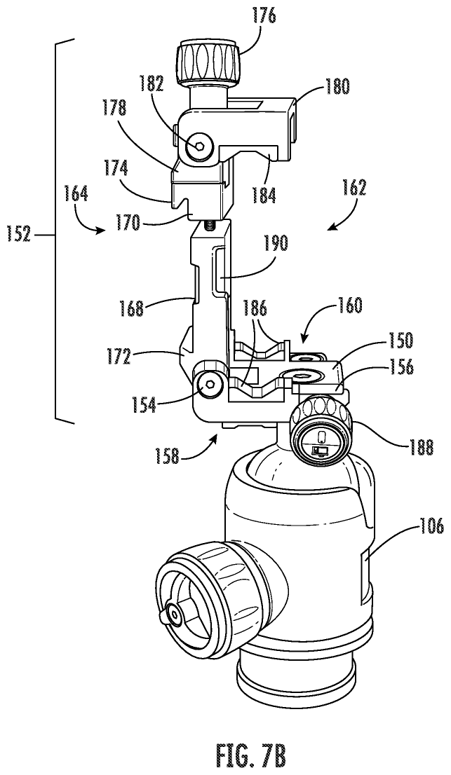

FIGS. 7A and 7B are more detailed views of mounting device 102. FIG. 7A shows mounting device 102 in a closed position while FIG. 7B shows mounting device 102 in an open position. FIGS. 7A and 7B are best viewed together in the following description.

In general, mounting device 102 includes base 150 having a base bottom surface 158 secured to tripod head 106 and a base top surface 160, and a platform 152 having a platform top surface 164 and a platform bottom surface 162 forming a smartphone clamp. A first hinge 154 connects base 150 and platform 152 along one edge. A retaining clasp 156 is movable between a camera setting for retaining the platform bottom surface against the base top surface and a smartphone setting for releasing the platform from the base in the open position.

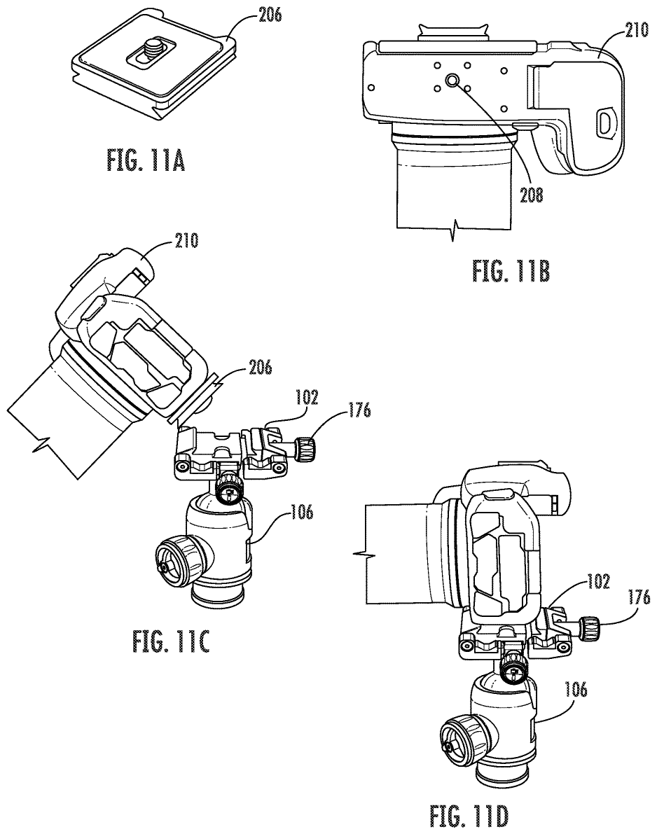

In the closed position shown in FIG. 7A, platform 152 includes a plate 168 and a first bracket 170 that cooperate to provide quick release (QR) receiver 166 for receiving a QR plate (FIG. 11A) that has been attached to an image capture device such as a camera. Plate 168 includes first flange 172. First bracket 170 includes a second flange 174 that cooperates with the first flange to form QR receiver 166. A locking knob 176 extends from an end of platform 152 opposite first hinge 154 and is threaded into first bracket 170 and plate 168. Locking knob 176 provides the quick release functionality of QR receiver 166. The turning locking knob 176 may be rotated to move first bracket 170 between a locked position where a QR plate is secured between first flange 172 and second flange 174, and a released position, so that a QR plate may be separated from QR receiver 166 and mounting device 102.

Platform 152 also includes a second bracket 178. An extension 180 is connected to second bracket 178 by second hinge 182. An upper clamping surface 184 on extension 180 cooperates with lower clamping surface 186 to form a smartphone mount. Upper and lower clamping surfaces 184 may be made from a resilient material such as rubber and may be formed as two separate surfaces on either side of base 150 and extension 180. Second bracket 178 may be generally formed in a horseshoe shape so that locking knob may pass through second bracket 178 and into first bracket 170. Second bracket 178 may be pulled away from first bracket 170 using a spring-loaded mechanism which will be described below. The spring-loaded mechanism operates independently of locking knob 176. When mounting device is in the open position, first bracket 170 may be positioned against plate 168 while second bracket 178 may be pulled away from first bracket 170 to allow for insertion of a smartphone between upper clamping surface 184 and lower clamping surface 186. Subsequently, second bracket 178 may be released so that the smartphone is securely retained by mounting device 102. Locking knob 176 may be rotated to move first bracket 170 away from plate 168 independently of the spring-loaded mechanism of second bracket 178 to provide a larger smartphone mount.

Mounting device 102 may be converted between closed and open positions using retaining clasp 156. Mode locking knob 188 secures retaining clasp 156 to base 150. Rotating mode locking knob 188 moves retaining clasp 156 relative to base 150. Plate 168 includes tab 190 adjacent to retaining clasp 156. As will be discussed in more detail below, when mounting device 102 is in the closed position, retaining clasp 156 is positioned against base 150 and over tab 190 to secure platform bottom surface 162 against base top surface 160. Rotating mode locking knob 188 allows retaining clasp 156 to move away from base 150 through the use of a spring between retaining clasp 156 and base 150, thus releasing tab 190 and platform 152 to move into the open position of mounting device 102. Camera indicia 192 and smartphone indicia 194 may be provided on mode locking knob 188.

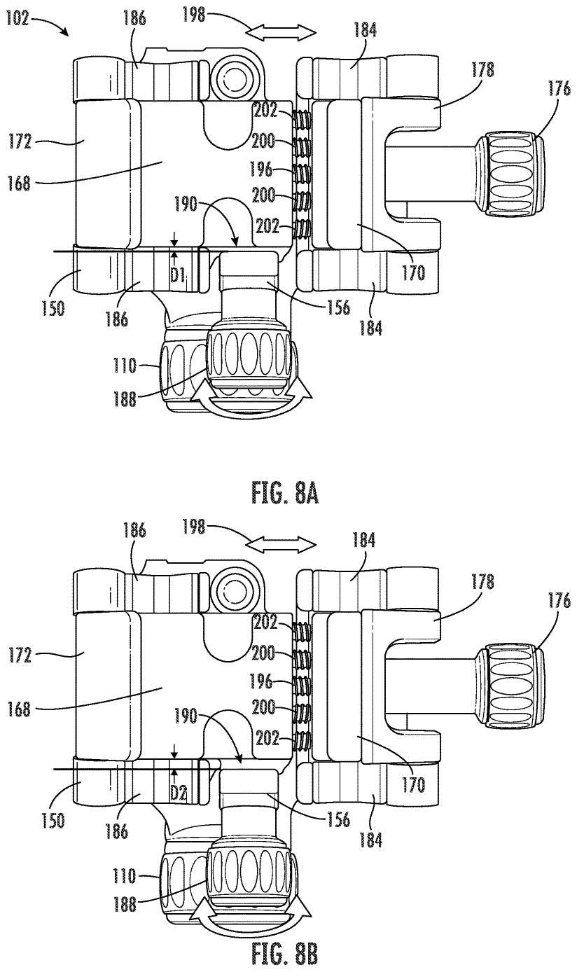

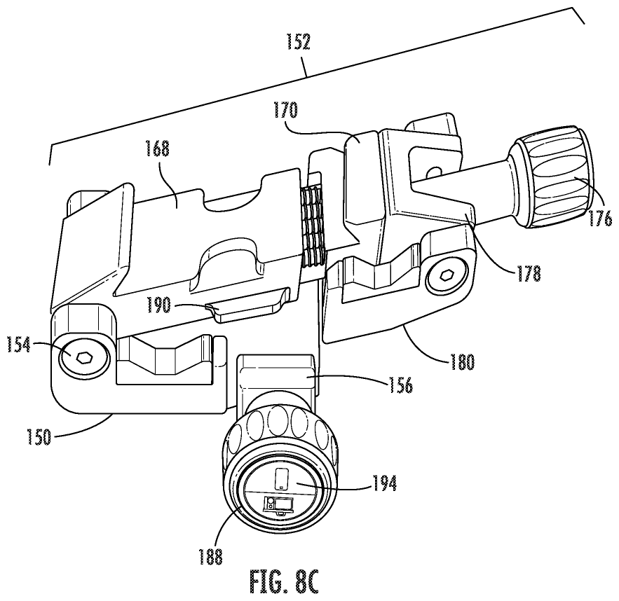

FIGS. 8A and 8B show top views of mounting device 102 to illustrate the operation of mode locking knob 188 in more detail. FIG. 8C shows mounting device 102 in a partially open position. FIGS. 8A-8C are best viewed together in the following description.

In FIG. 8A, mode locking knob 188 is turned to the closed, or camera, position of FIG. 7A so that retaining clasp 156 is pressed against base 150 over tab 190 of plate 168. A small distance D1 may be present between retaining clasp 156 and plate 168 due to manufacturing tolerances and other factors. In FIG. 8B, mode locking knob 188 is rotated to all retaining clasp 156 to move away from base 150 through a spring-loaded mechanism (not shown). A distance D2 separates retaining clasp 156 and plate 168, thus exposing tab 190 and allowing platform 152 to be moved up and away from base 150 into the open, or smartphone, position of FIG. 7B. In embodiments, D2>D1.

FIG. 8A also illustrates mechanisms for providing the movement of first bracket 170 and second bracket 178. Threaded shaft 196 is secured to plate 168 and extends through first bracket 170 into internal threads inside locking knob 176. As locking knob 176 is rotated around threaded shaft 196, first bracket 170, as well as second bracket 178, are moved relative to plate 168 in the direction of arrow 198. The combination of threaded shaft 196 and locking knob 176 provides precise positioning of first bracket 170 in either the camera mode or the smartphone mode of mounting device 102. For stable motion of first bracket 170, rods 200 are positioned on either side of threaded shaft 196. Rods 200 are secured in first bracket 170 and extend into plate 168 for a distance at least greater than the range of motion provided by threaded shaft 196. Rods 200 may be spring-loaded.

Second bracket 178 is secured to spring loaded rods 202 on either side of rods 200. Spring-loaded rods 202 pass through first bracket 170, then through springs before entering plate 168. Second bracket 178 may be pulled away from first bracket 170 as far as locking knob 176 so that a smartphone may be placed between upper clamping surface 184 and lower clamping surface 186. Spring-loaded rods 202 urge second bracket 178 to move back towards first bracket 170 to hold a smartphone securely, and extend into plate 168 for a distance at least greater than range of motion provided for second bracket 178.

FIG. 8C shows mounting device 102 in a partially open position. Mode locking knob 188 is rotated into smartphone mode as shown by smartphone indicia 194 to release tab 190. Platform 152 is partially rotated away from base 150 around hinge 154.

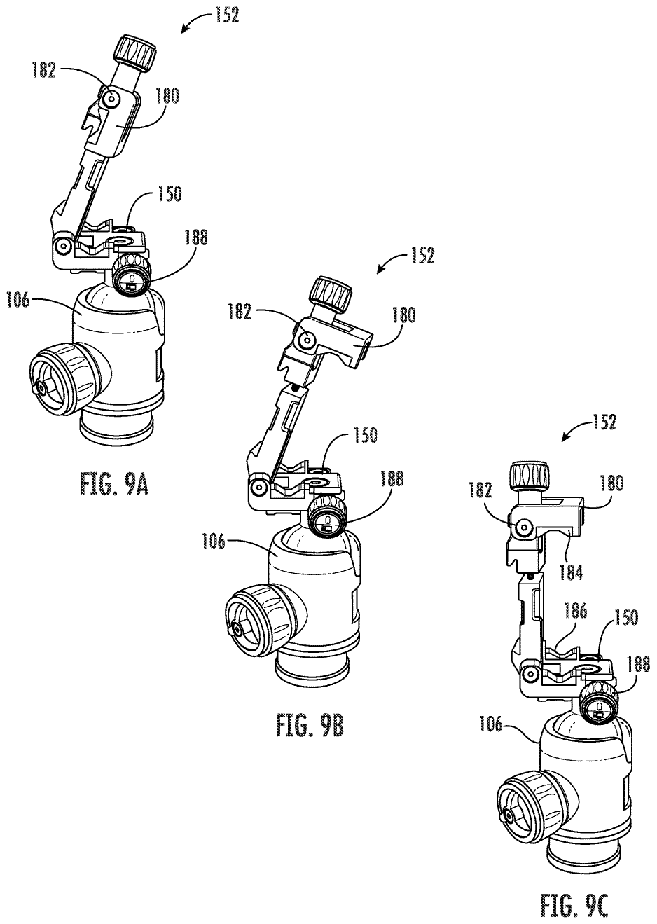

FIGS. 9A-9C show steps of converting mounting device 102 from a camera mode to a smartphone mode. In FIG. 9A, platform 152 is partially lifted away from base 150. In FIG. 9B, extension 180 is rotated away from platform 152 around second hinge 182. In FIG. 9C, platform 152 is fully open and prepared to accept insertion of a smartphone between upper clamping surface 184 and lower clamping surface 186.

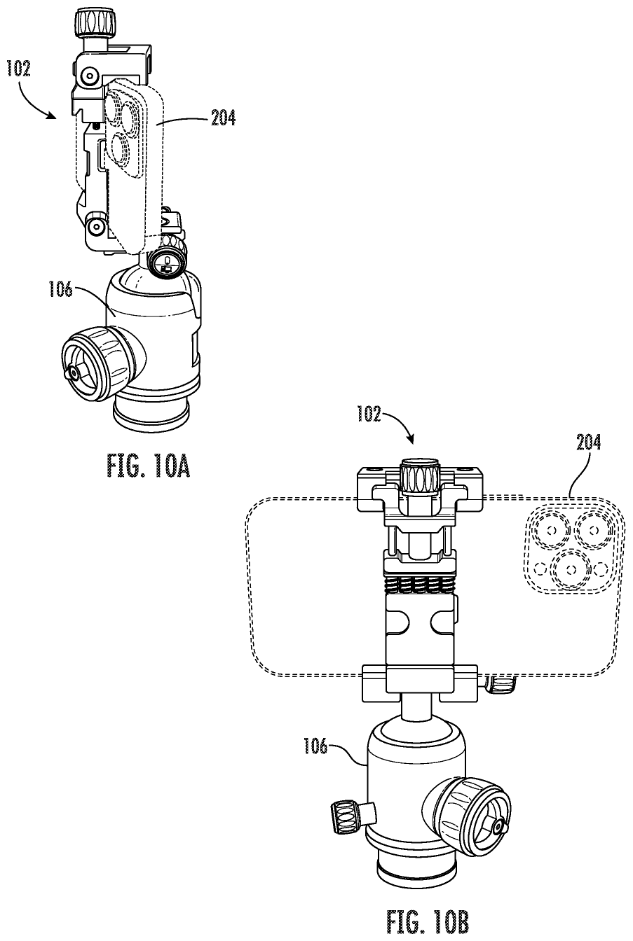

FIGS. 10A-10B show side and back views of mounting device 102 with a smartphone held between upper clamping surface 184 and lower clamping surface 186. In embodiments, mounting device 102 may securely hold smartphones and other devices having a range of dimensions. Although mounting device 102 is shown and described for use with a smartphone, devices of other sizes may also be used, including tablets, for example.

FIGS. 11A-11D show the operation of a QR system with mounting device 102. FIG. 11A shows a Quick Release (QR) plate 206 in perspective view. FIG. 11B shows the base of a representative camera without QR plate 206 installed in ¼″-20 threaded port 208. FIG. 11C shows camera 210 with QR plate 206 installed in threaded port 208. FIG. 11D shows camera 210 mounted in the QR receiver of mounting device 102.

Nearly all cameras have a standard ¼″-20 threaded port in the base. Traditional tripods connect to a camera by means of a compatible bolt which screws into the camera's base. It is a relatively secure system, but it is slow to connect and disconnect. A quick release system uses a plate (referred to as a QR plate) which is attached to the base of the camera. This is semi-permanent, meaning the photographer will typically leave a QR plate on each camera all the time; however, these plates can be removed if needed.

Changes may be made in the above methods and systems without departing from the scope hereof. It should thus be noted that the matter contained in the above description or shown in the accompanying drawings should be interpreted as illustrative and not in a limiting sense. Herein, and unless otherwise indicated: (a) the adjective “exemplary” means serving as an example, instance, or illustration, and (b) the phrase “in embodiments” is equivalent to the phrase “in certain embodiments,” and does not refer to all embodiments. The following claims are intended to cover all generic and specific features described herein, as well as all statements of the scope of the present method and system, which, as a matter of language, might be said to fall therebetween.

What is claimed is:

1. A mounting device for securing image capture devices, the mounting device being convertible between an open position and a closed position, and the mounting device comprising:
a base having a base bottom surface securable to a tripod head and a base top surface;
a platform having a platform top surface forming a quick release (QR) receiver and a platform bottom surface forming a mobile device clamp;
a hinge connecting an edge of the platform to an edge of the base; and
a retaining clasp for retaining the platform bottom surface against the base top surface in the closed position and releasing the platform from the base in the open position.

2. The mounting device of claim 1, wherein the platform comprises:
a plate connected to the base by the hinge; and
a first bracket connected to the plate by a plurality of threaded rods so that the first bracket can be moved relative to the plate.

3. The mounting device of claim 2, wherein a top surface of the plate includes a first flange adjacent to the hinge.

4. The mounting device of claim 3, wherein the first bracket comprises a second flange on the top surface that cooperates with the first flange to form a quick release receiver.

5. The mounting device of claim 4, wherein the first bracket comprises a second flange on the top surface that cooperates with the first flange to form a quick release receiver.

6. The mounting device of claim 2, wherein a top surface of the base comprises a lower clamping surface.

7. The mounting device of claim 6, wherein the platform comprises:
a second bracket connected to the first bracket and the plate by a spring-loaded rod so that the platform can be lengthened by pulling the second bracket away from the first bracket.

8. The mounting device of claim 7, wherein the second bracket includes an extension hinged to a bottom surface of the second bracket, the extension including an upper clamping surface cooperates with the lower clamping surface to form a mobile device mount.

9. The mounting device of claim 7, wherein the second bracket includes a clamp attached to the second bracket by a hinge.

10. The mounting device of claim 7, wherein the platform includes a locking knob passing through the second bracket, wherein rotating the locking knob moves the first bracket relative to the plate.

11. The mounting device of claim 1, comprising:
a mode locking knob securing the retaining clasp to the base,
wherein rotating the mode locking knob moves the retaining clasp relative to the base.

12. A tripod, comprising:
a yoke with a central opening;
three legs hingeably attached to the yoke around a circumference of the yoke;
a tripod head with a first threaded connection mechanism;
a mini tripod assembly, comprising:
a second threaded connection mechanism compatible with the first threaded connection mechanism of the tripod head;
a minibase connected to the second threaded connection mechanism; and
three minilegs hingeably attached to the minibase; and
a release knob in the yoke for releasably retaining the mini tripod assembly in the central opening of the yoke.

13. The tripod of claim 12, wherein at least one leg of the three legs is attached to the tripod at a first end of the at least one leg with a third threaded connection mechanism.

14. The tripod of claim 12, wherein the first threaded connection mechanism is compatible with the first threaded connection mechanism of the tripod head.

15. The tripod of claim 13, wherein the at least one leg comprises a fourth threaded connection mechanism at a second end of the at least one leg opposite first end, the fourth threaded connection mechanism compatible with the second threaded connection mechanism of the mini tripod assembly.

16. The tripod of claim 12, wherein the minilegs are evenly distributed around the circumference of the minibase.

17. The tripod of claim 12, wherein the three legs are evenly distributed around the circumference of the yoke.

18. The tripod of claim 12, wherein the tripod head further comprises a platform for connecting an image capture device.
